(19) United States
(12) Patent Application Publication
(10) Pub. No.: US 2011/0119007 A1
(43) Pub. Date: May 19, 2011

(54) METHOD AND SYSTEM FOR DETERMINING THE TIME-OF-FLIGHT OF A SIGNAL

(75) Inventors: Steve MARTIN, Fort Collins, CO (US); Osvaldo BUCCAFUSCA, Fort Collins, CO (US)

(73) Assignee: Avago Technologies Wireless IP (Singapore) Pte. Ltd., Singapore (SG)

(21) Appl. No.: 12/620,649

(22) Filed: Nov. 18, 2009

(51) Int. Cl. G04F 10/00; G06F 19/00

(52) U.S. Cl. 702/66; 702/176

(57) ABSTRACT

A method for determining the time-of-flight of a signal includes: receiving a signal having a series of pulses of period T, the series of pulses having a phase transition provided therein windowing the received signal with a window having a width substantially the same as T to determine a magnitude and phase of the windowed signal at a frequency F=1/T; sliding the window in time, one period T at a time, with respect to the received signal to produce N sets of magnitude and phase data at the frequency F; from the N sets of magnitude and phase data, determining a time when the phase transition occurs in the received signal; and determining a time-of-flight of the signal from the time when the phase transition occurs in the received signal.

### BACKGROUND

There are a number of various applications where determining the time-of-flight (TOF) of a signal is required. These applications include laser range finders, ultrasonic level detectors, and ultrasonic flow meters. In general, a system for determining TOF can take two forms: pitch-catch and pulse-echo. FIG. 1A illustrates an example of a pitch-catch system, and FIG. 1B shows an example of a pulse-echo system. In either configuration, a device 110 transmits a signal at a predetermined time and the signal is then sensed some time later. In a pitch-catch system shown in FIG. 1A, the signal is sensed by a second, separate, receive (RX) device 120. In the pulse-echo system shown in FIG. 1B, the signal is sensed with the same device 110 that transmitted the signal—i.e., the device 110 is both the TX device and the RX device. The time it takes the signal to traverse from the TX device to the RX device is the time-of-flight of the signal.

A simple threshold technique might be used to determine time-of-flight. However, in many systems this will provide a less than desirable resolution.

For example, when a system employs ultrasonic transducers, these transducers are resonant devices with a limited bandwidth, and therefore the signal has an associated envelope with a rise and fall time. Any additive noise in the system could cause false readings by either accelerating or decelerating the threshold crossing. This is commonly referred to as cycle slip. A number of techniques have been used to improve the resolution of the TOF measurement including demodulating the envelope and cross-correlation methods. However, the former technique still relies heavily on the amplitude information in the signal and the latter technique is easily corrupted by noise in the signal.

Achieving a required degree of accuracy in the time-of-flight measurement is both critical and difficult.

What is needed, therefore, is an accurate method of determining the time-of-flight of a signal. What is also needed is a system which can accurately measure the time-of-flight of a signal.

### SUMMARY

In an example embodiment, a method comprises: receiving a signal having a first series of first pulses each having a fundamental period T and each being substantially at zero degrees in phase with respect to each other, and having a second series of second pulses following in time after the series of first pulses, the second pulses also having the fundamental period T and each being shifted in phase with respect to the first pulses; (1) providing a window having a width substantially the same as the fundamental period T; (2) aligning the window with a w^{th} interval of the received signal within the first series of first pulses; (3) multiplying the received signal by the window to produce a product for the w^{th} interval of the received signal; (4) determining a magnitude and phase of the product for the W^{th} interval at a fundamental frequency F=1/T; (5) incrementing w by one, delaying the window by one fundamental period, and repeating steps (2) through (4) to produce N sets of magnitude and phase data at the fundamental frequency F for N intervals of the received signal spanning at least one of the first pulses and at least one of the second pulses; (6) from the N sets of magnitude and phase data, determining when a phase transition occurs in the received signal due to a transition from the first pulses to the second pulses; and (7) determining a time-of-flight of the signal from a time when the phase transition occurs in the received signal.

In another example embodiment, a method comprises: receiving a signal having a series of pulses of period T, the series of pulses having a phase transition provided therein; windowing the received signal with a window having a width substantially the same as T to determine a magnitude and phase of the windowed signal at a frequency F=1/T; sliding the window in time, one period T at a time, with respect to the received signal to produce N sets of magnitude and phase data at the frequency F; from the N sets of magnitude and phase data, determining a time when the phase transition occurs in the received signal; and determining a time-of-flight of the signal from the time when the phase transition occurs in the received signal.

In yet another embodiment, a system, comprises: a receiver configured to receive a signal having a series of pulses of period T, the series of pulses having a phase transition provided therein; and a processor configured to execute an algorithm. The algorithm comprises: windowing the received signal with a window having a width substantially the same as T to determine a magnitude and phase of the windowed signal at a frequency F=1/T; sliding the window in time, one period T at a time, with respect to the received signal to produce a plurality of N sets of magnitude and phase data at the frequency F; from the N sets of magnitude and phase data, determining a time when the phase transition occurs in the received signal; and determining a time-of-flight of the signal from the time when the phase transition occurs in the received signal.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions shown in the drawings may be arbitrarily increased or decreased for clarity of discussion. Wherever applicable and practical, like reference numerals refer to like elements.

FIG. 1A illustrates an example of a time-of-flight (TOF) system with a pitch-catch configuration.

FIG. 1B illustrates an example of a time-of-flight (TOF) system with a pulse-echo configuration.

FIG. 2 illustrates three embodiments of a signal comprising a series of having a phase transition therein.

FIG. 3 illustrates stepping a window through a received waveform and computing phase and magnitude of a fast Fourier transform of the windowed signal at the fundamental frequency of the received signal.

FIG. 4 illustrates window-by-window magnitude and phase responses of a received signal at the fundamental frequency of the received signal.

FIG. 5. illustrates a window-by-window plot of the absolute value of the derivative of the phase response of a received signal at the fundamental frequency of the received signal.

FIG. 6 illustrates a flow chart of one embodiment of a method of determining the time-of-flight of a signal.

FIG. 7 illustrates one embodiment of a multi-pass algorithm for determining the time-of-flight of a signal.

FIG. 8 illustrates one embodiment of a method for determining the time-of-flight of a signal where the method employs the initial phase at the fundamental frequency of a received signal.

FIG. 9 illustrates a flow chart of another embodiment of a method of determining the time-of-flight of a signal.

FIG. 10 illustrates a flow chart of yet another embodiment of a method of determining the time-of-flight of a signal.

FIG. 11 illustrates on embodiment of a system for measuring the time-of-flight of a signal.

FIG. 12 illustrates a flow chart of another embodiment of a method of determining the time-of-flight of a signal.

FIG. 13 illustrates an example of limiting a received data set to a region of interest around a time where a phase transition occurs.

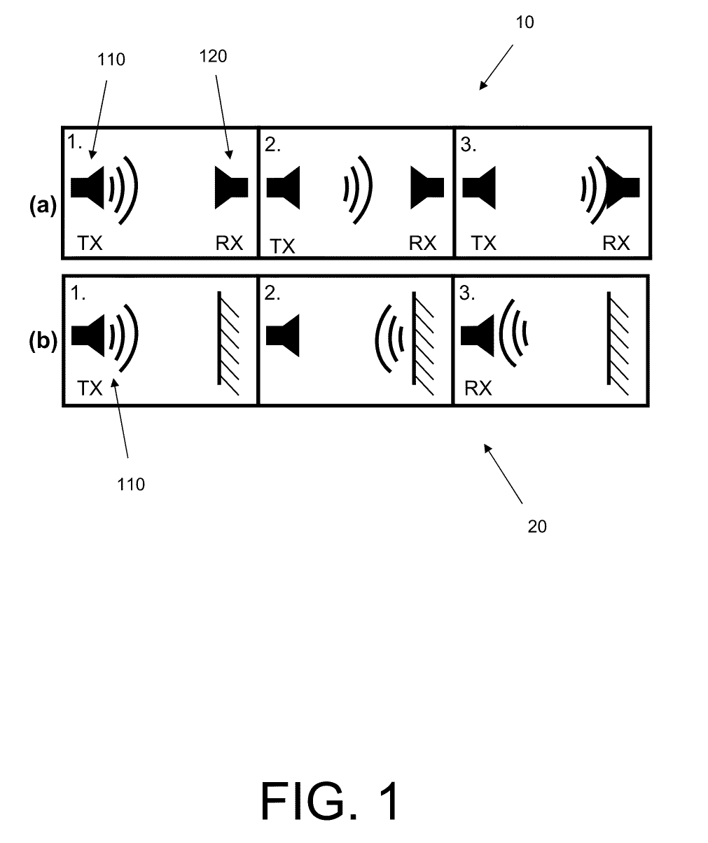

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

Unless otherwise noted, when a first device is said to be connected to a second device, this encompasses cases where one or more intermediate devices may be employed to connect the two devices to each other. However, when a first device is said to be directly connected to a second device, this encompasses only cases where the two devices are connected to each other without any intermediate or intervening devices. Similarly, when a signal is said to be coupled to a device, this encompasses cases where one or more intermediate devices may be employed to couple the signal to the device. However, when a signal is said to be directly coupled to a device, this encompasses only cases where the signal is directly coupled to the device without any intermediate or intervening devices.

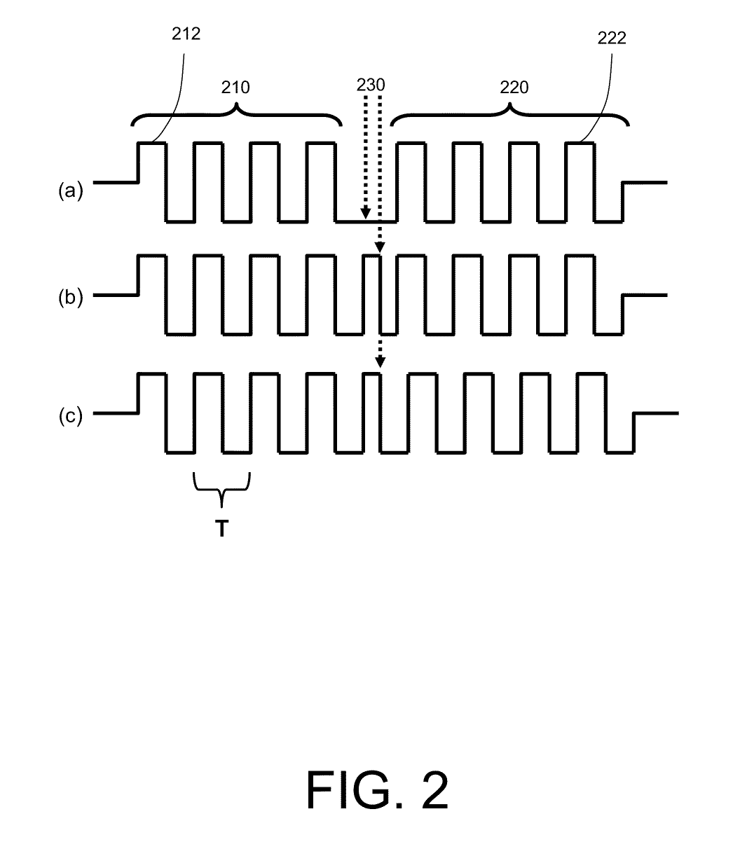

FIG. 2 illustrates three embodiments of a signal comprising a series of pulses having a phase transition 230 provided therein. The period of each pulse will be called the fundamental period, T, and the inverse fundamental period of the pulses will be called the fundamental frequency, F. In particular, FIG. 2 illustrates three transmit waveforms each including a first series 210 of first pulses (pre-pulses) 212 each having the fundamental period T and each being substantially at zero degrees in phase with respect to each other, and having a second series 220 of second pulses (post-pulses) 222 following in time after the first series of first pulses, the second pulses also having the fundamental period and each being shifted in phase with respect to the first pulses. Waveforms (a) and (b) in FIG. 2 are two different embodiments of waveforms where phase transition 230 is 180 degrees. Waveform (c) in FIG. 2 is an example of a waveform where phase transition 230 is 90 degrees.

In a beneficial arrangement, embodiments of a time-of-flight (TOF) measurement system use a short-time or transient Fourier transform technique to extract the magnitude and phase of a transmitted signal in a transient nature so as to determine a time t_{φRx} when the phase transition is received. By comparing the time t_{φRx} to a known time t_{φTX} when the phase transition 230 was transmitted, the time-of-flight t_{TOF} of the signal can be determined.

In embodiments described in greater detail below, the received signal is digitized and sampled to produce digital samples of the received signal. A window (beneficially, a square window) of width equal to the fundamental period T is multiplied by the digital samples of the received waveform, and a fast Fourier transform (FFT) of the product is computed. The window is then sequentially stepped through the received signal, one fundamental period T at a time, and the process is repeated for each window position. This process builds up a dataset of magnitude and phase values of the received signal at the fundamental frequency F. From this dataset, the window where the phase transition is received can be determined, and for this, the time-of-flight t_{TOF} of the signal can be determined.

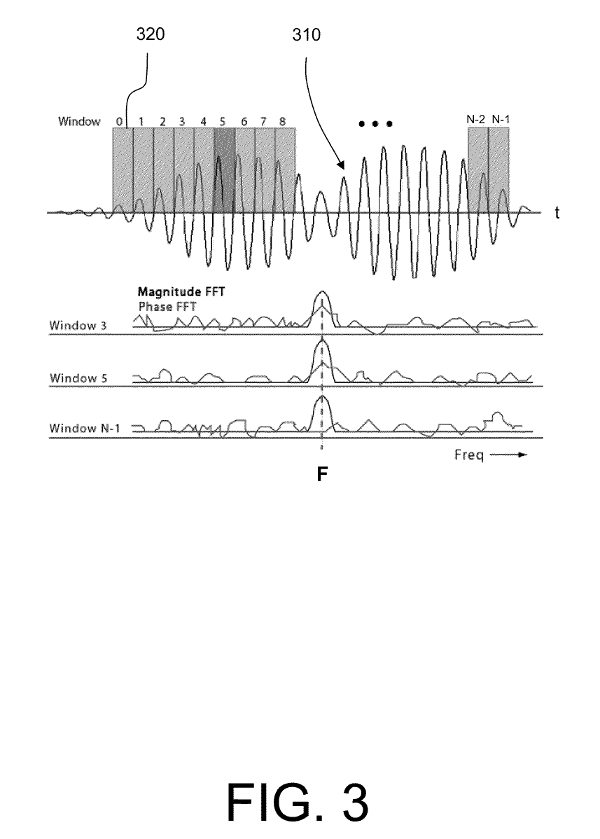

FIG. 3 illustrates stepping a window 320 through a received signal 310 in N intervals or periods, one fundamental period T at a time, and computing the phase and magnitude of a fast Fourier transform of the windowed signal at the fundamental frequency F of the received signal 310. As can be seen in FIG. 3, the first window interval (windows index w=0) is selected to correspond to a portion of received signal 310 before the phase transition is expected to be received, and the last window interval (window index w=(N−1)) is selected to correspond to a portion of received signal 310 after the phase transition is expected to be received. Each window interval is located immediately after its preceding window interval—i.e., each window interval starts one fundamental period T after the preceding window interval started.

Note that due to the resonant nature of the system in this embodiment, the pulses in received signal 310 are sinusoidal in nature. The magnitude and phase of the FFT are easily calculated by the following formulas:

$$\begin{matrix}\vert {X}_{w} \vert = \sqrt{{[ Re \{ {X}_{k} \} ]}^{2} + {[ Im \{ {X}_{k} \} ]}^{2}} & ( 1 ) \\ ∠ {X}_{w} = arctan [ \frac{Im \{ {X}_{k} \}}{Re \{ {X}_{k} \}} ] & ( 2 )\end{matrix}$$

where X is the complex result of the FFT operation, w is the window index {0, N−1} and k is the frequency at which the FFT was calculated.

As can be seen in FIG. 3, there is only sufficient energy content at the fundamental frequency, F. Thus, k is set equal to the fundamental frequency F. Utilizing only the magnitude and phase data at the fundamental frequency F, one can build up a window-by-window magnitude and phase response of received signal 310.

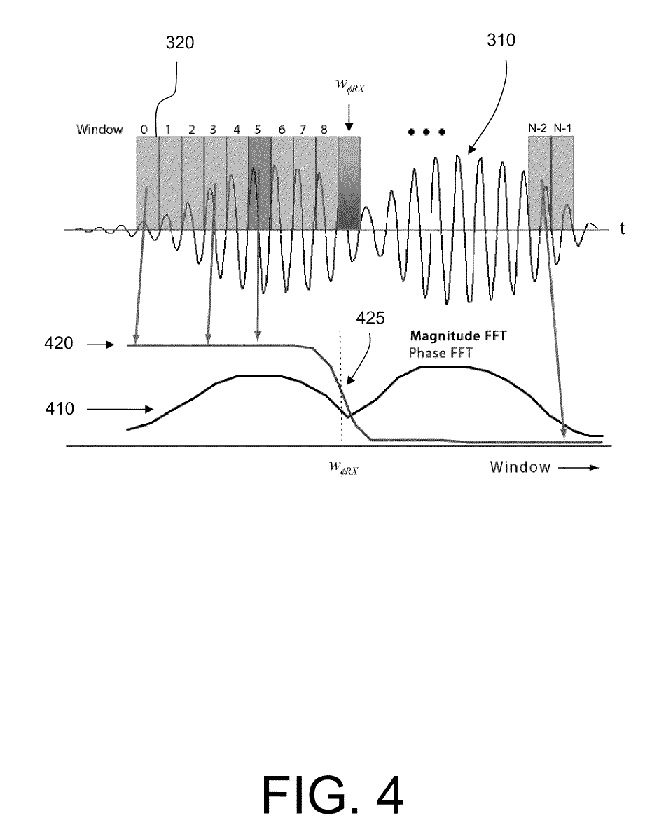

FIG. 4 illustrates a window-by-window magnitude response 410 and phase response 420 of a received signal 310 at the fundamental frequency F corresponding to the period T of the pulses in the received signal. In FIG. 4, it is easy to see where the phase transition 425 occurs as the phase shifts 180 degrees. Taking the absolute value of the derivative of the phase response 420 makes the determination of phase transition 425 in received signal 310 easier for an automated algorithm executed by a processor.

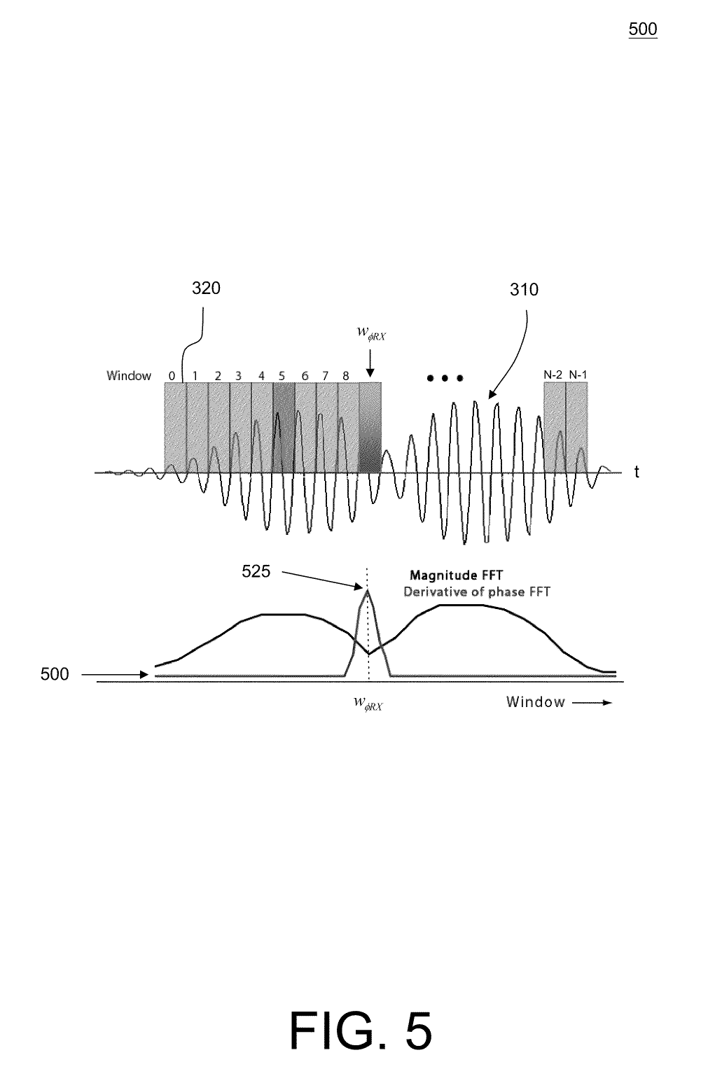

FIG. 5 plots a window-by-window response 500 of the absolute value of the derivative of the phase of received signal 310 at the fundamental frequency F of received signal 310.

The index w of the window interval during which the maximum 525 of the absolute value of the derivative of the phase of the FFT at the fundamental frequency F is located, is considered to be the window index w_{φRX} in which the received phase transition 425 occurred in received signal 310. This value can be turned into the time t_{φRX} of the received phase transition 425 by:

t_{φRX}=T*w_{φRX} (3)

Since, the time t_{φTX} of the transmitted phase transition 230 can be precisely controlled by the initiating circuit in the transmit circuitry (e.g. a microcontroller, FPGA, DSP, etc.), the time-of-flight, t_{TOF}, of the signal can be determined by:

t_{TOF}=t_{φRX}−t_{φTX} (4)

The resolution of the time-of-flight t_{TOF} determined by this procedure as described thus far is limited by the period of the window 320, which is the fundamental period T. Thus the TOF that can be determined from the procedure described thus far can only be as accurate as T.

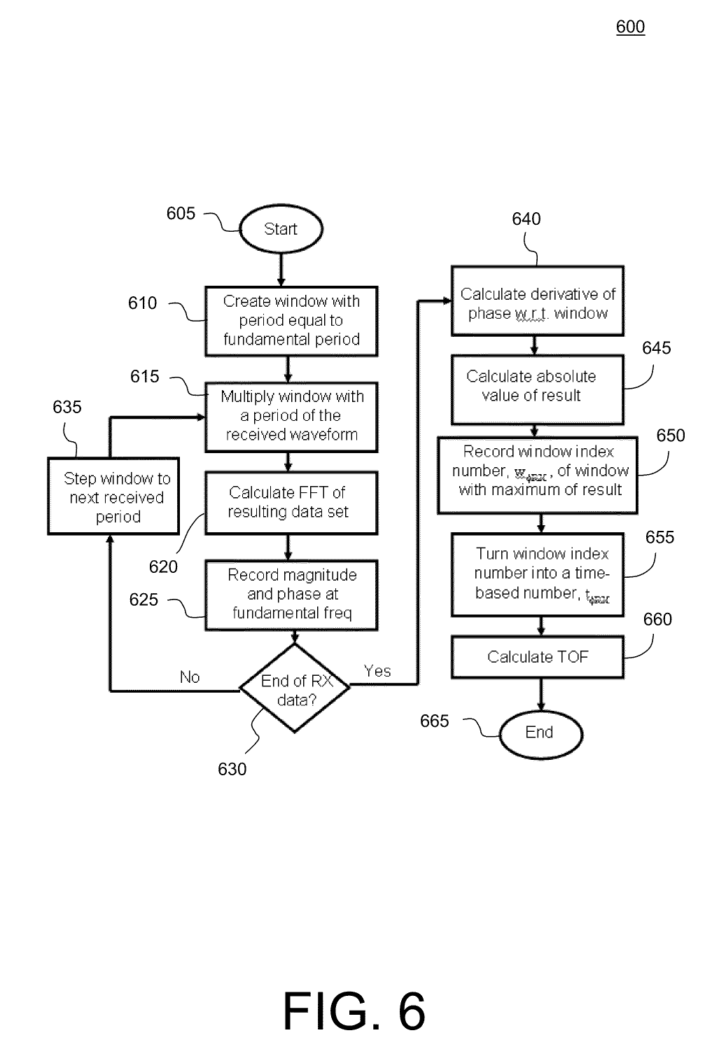

FIG. 6 illustrates a flow chart of one embodiment of a method 600 of determining the time-of-flight t_{TOF} of a signal.

In a step 605, a time-of-flight measurement procedure is initiated.

In a first step 610, a window 320 is created with period equal to the fundamental period T of the pulses in the received signal 310.

In a step 615, a selected period or interval of the received signal—or more precisely digital samples of the received signal—is multiplied by the window 320. The initial period or interval of the received signal is selected to be prior to the received phase transition 425.

In a step 620, a fast Fourier transform (FFT) is calculated for the product of window 320 and received signal 310 at the current window interval.

In a step 625, the magnitude and phase of the FFT data for the product of window 320 and received signal 310 at the current window interval at the fundamental frequency F is saved for later processing, as will be explained below.

In a step 630, it is determined with the last interval or period of received signal 310 has been reached. For example, when N window intervals (i.e., window index wε(0, N−1)) of received signal 310 are to be analyzed, then step 630 determines if w=N−1.

If not, then the process proceeds to step 635 where the window index w is incremented, and then the process returns to step 615.

Once all of the N window intervals are processed, then the process continues to step 640. In step 640, the derivative of the phase data at the fundamental frequency F as a function of window index w is calculated with respect to the window index w.

Then, in step 645, the magnitude of the derivative of the phase data at the fundamental frequency F as a function of window index w is calculated.

In step 650, the index W the window interval in which the maximum 525 of the absolute value of the derivative of the phase of the FFT at the fundamental frequency F is located.

In step 655, the window w_{φRX} is converted into time t_{φRX} of the received phase transition 425 using equation (3) above.

In step 660, the time-of-flight t_{TOF} of the signal is determined using equation (4) above.

Finally, in step 665, the process ends.

Due to hardware limitations, cost-constraints, calculation efficiency, or speed, it may be undesirable to calculate an FFT for each windowed data set. A more efficient algorithm involves multiplying the windowed data set by a cosine and sine waveform as explained below.

The equation for the discrete Fourier transform of a data set, x, is:

$${X}_{k} = {\sum }_{n = 0}^{L - 1} {x}_{n} {e}^{[ \frac{- i ( 2 π k ) n}{L} ]} \qquad ( 5 )$$

where k corresponds to frequency in (radians/second), L is the length of the windowed data set, and i is the imaginary number SQRT(−1).

Since the fundamental frequency F of the transmit waveform is known, k is set to this frequency. The complex exponential can be rewritten as:

e^{-ix}=cos(x)−i sin(x) (6)

Thus, the Fourier transform can be rewritten:

$${X}_{F} = {\sum }_{n = 0}^{L - 1} {x}_{n} cos ( \frac{2 π Fn}{L} ) - i {\sum }_{n = 0}^{L - 1} {x}_{n} sin ( \frac{2 π Fn}{L} ) \qquad ( 7 )$$

and can be separated into real and imaginary components, given by:

$$\begin{matrix}Re \{ {X}_{F} \} = {\sum }_{n = 0}^{L - 1} {x}_{n} cos ( \frac{2 π Fn}{L} ) & ( 8 ) \\ Im \{ {X}_{F} \} = - {\sum }_{n = 0}^{L - 1} {x}_{n} sin ( \frac{2 π Fn}{L} ) & ( 9 )\end{matrix}$$

The magnitude and phase of the signal can easily be calculated from the real and imaginary terms using the formulas in the previous algorithm. Thus, the calculation of the magnitude and phase of the signal can be simplified by multiplying the windowed data set by a cosine and sine term of proper frequency to find the real and imaginary components, rather than performing the FFT in the data set. So in some embodiments, the method 600 can be modified by changing step 620 to multiply the windowed data set by a cosine and sine waveform as explained above, instead of calculating the FFT. The subsequent steps in method 600 would remain the same.

In yet another alternative algorithm, a wavelet transform can be substituted for the Fourier transform in step 620. The wavelet transform may be advantageous when both improved frequency and time resolution is required of the short-time FFT. After computation of the complex data set via the wavelet transform, the algorithm would follow the remaining steps in method 600.

In some applications it may be desirable or necessary to provide a time-of-flight accuracy greater than the fundamental period T of the pulses in the transmitted signal. One solution to enhance the accuracy is to perform multiple passes through the algorithm while successively increasing the starting point of the first window. This improves the time-of-flight accuracy to that of the sampling rate, F_{SAMP}, of the received signal. A detailed description follows.

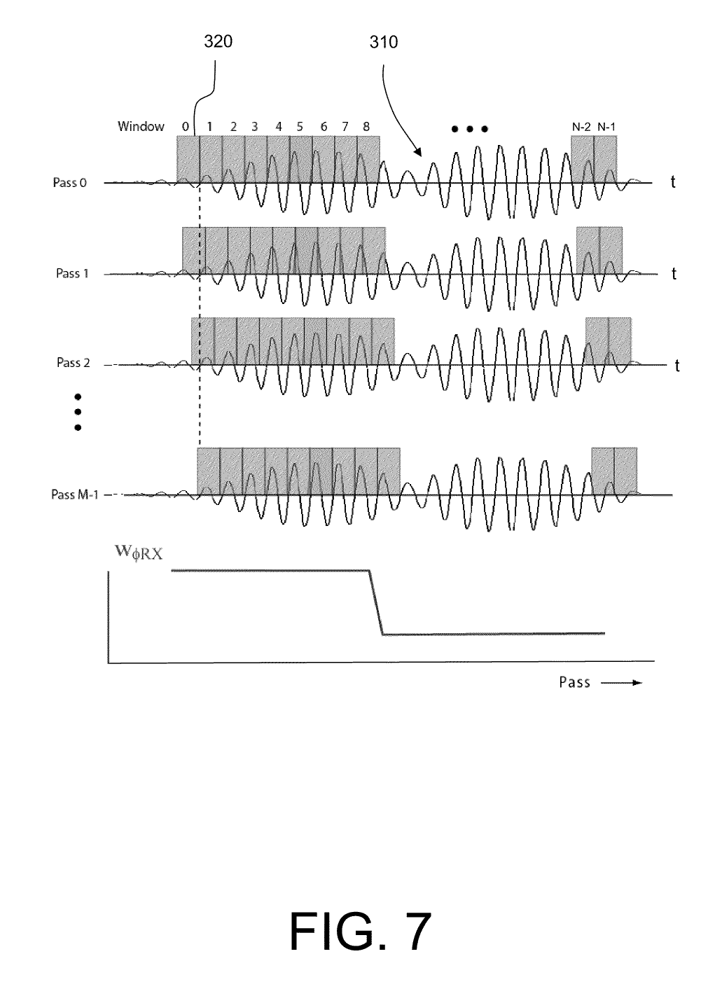

FIG. 7 illustrates one embodiment of a multi-pass algorithm for determining the time-of-flight t_{TOF} of a signal.

Let M, be the number of sampled data points in each period T of received signal 310. The multi-pass algorithm begins the same as the method 600 by performing steps 605-650 to determine the window w_{φRX0} in which the phase transition 425 in received signal 310 occurs. Then, the start time of the initial window period (w=0) is shifted to the right by one sampled data point (NOT one period T) in received signal 310, and steps 605-650 are repeated to determine the window w_{φRX1} in which the phase transition 425 occurs. This process is repeated until w_{φRX(m-1)} is determined. From this data, w_{φRX} be plotted versus pass number as shown in FIG. 7. The window w_{φRX} where the phase transition 425 occurs will start at an initial value, A, for pass 0, but at some pass later, will equal (A−1) and will continue at this new value until pass M−1. The pass which the shift occurs, P_{SH}, gives the location of the phase transition down to the resolution of the data samples within the window w_{φRX}. If no shift occurs after all M−1 passes, then P_{SH} defaults to 0. Thus, the time t_{φRX} of the phase transition 425 in received signal 310 is given by:

$${t}_{φ RX} = ( T * {w}_{φ RX 0} ) + \frac{{P}_{SH}}{{F}_{SAMP}} \qquad ( 10 )$$

Another embodiment of a method for determining the time-of-flight t_{TOF} of a signal improves the resolution of the measurement using the phase information of received signal 310. Utilizing the initial phase of received signal 310 as determined by the FFT can give subsample resolution of the time-of-flight t_{TOF} of the signal.

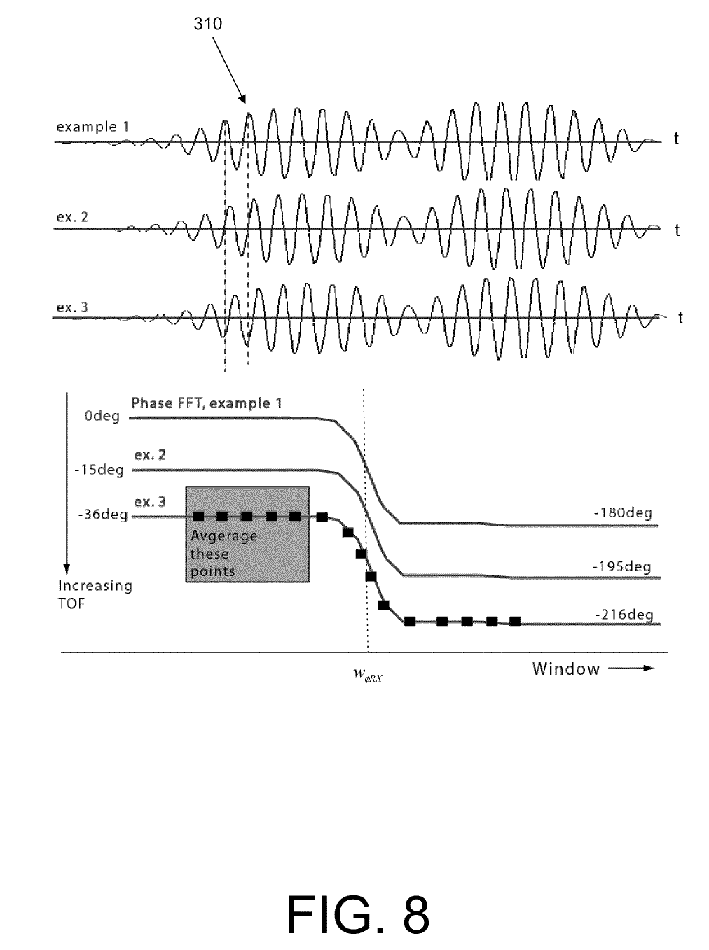

FIG. 8 illustrates another embodiment of a method 800 for determining the time-of-flight t_{TOF} of a signal, where the method employs the initial phase at the fundamental frequency F of received signal 310.

As the time-of-flight of a signal varies slightly due to temperature, density, flow, etc., the initial phase of the signal will vary. This variation in phase can be used to enhance the accuracy of the time-of-flight measurement for the signal. One method is to average the phase, PH_{AVG}, of the windows 320 prior to the phase transition 425 as determined by a method such as method 600. If we again have M sampled data points of the received signal per fundamental period, then the time t_{φRX} of the received phase transition 425 is given by:

$${t}_{φ RX} = ( T * {w}_{φ RX} ) - \frac{{PH}_{AVG} * T}{360} \qquad ( 11 )$$

where PH_{AVG} is given in degrees and a negative phase means a time lag of the signal.

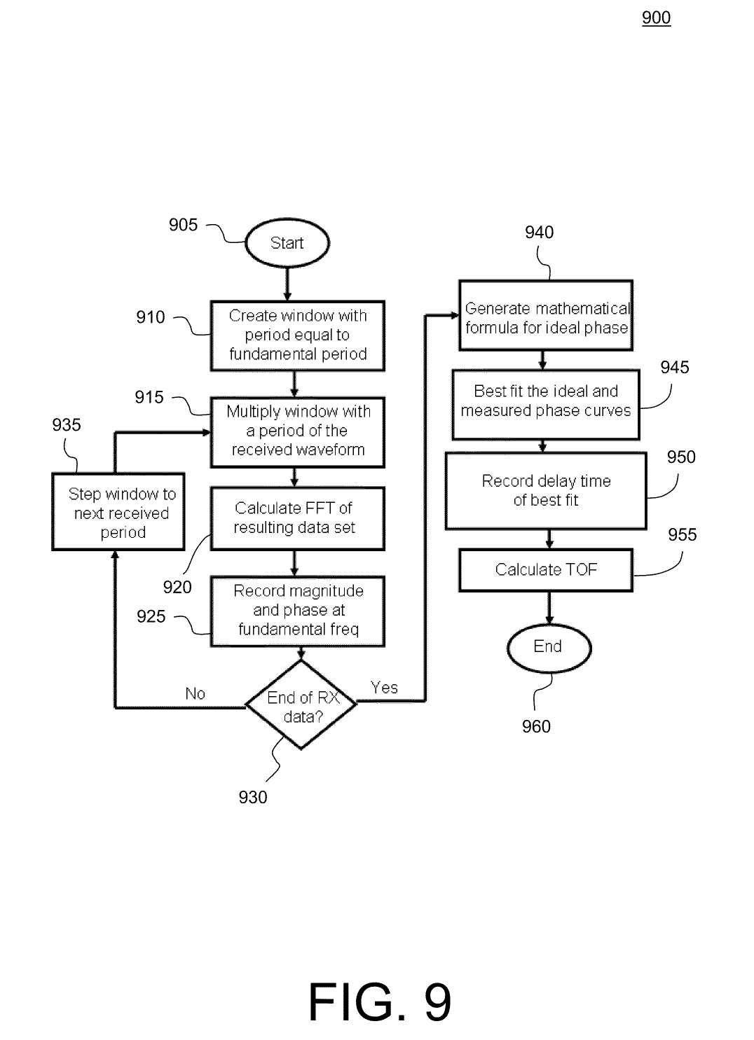

FIG. 9 illustrates a flow chart of another embodiment of a method 900 of determining the time-of-flight t_{TOF} of a signal.

In method 900, a data fitting routine is employed to match the measured phase response to an ideal phase response. Beneficially, this technique can provide subsample resolution.

Steps 905-935 of method 935 are the same as steps 605-635 of method 600 described above, and so a description thereof will not be repeated here.

In step 940, a mathematical formula representing an ideal phase vs. window curve is generated as:

$$g ( w ) = arctan [ \frac{f ( w )}{h ( w )} ] + {φ}_{o} \qquad ( 12 )$$

where:

$$\begin{matrix}f ( w ) = \{ \begin{matrix}0 & for w < {w}_{d} - x \\ sin [ \frac{π}{2 x} ( w - ( {w}_{d} - x - 0.4 ) ) ] & for w = {w}_{d} - x + 1 \\ sin [ \frac{π}{2 x} ( w - ( {w}_{d} - x ) ) ] & for {w}_{d} - x + 1 < w < {w}_{d} + x - 1 \\ sin [ \frac{π}{2 x} ( w - ( {w}_{d} - x + 0.4 ) ) ] & for w = {w}_{d} + x - 1 \\ 0 & for w > {w}_{d} + x\end{matrix} & ( 13 ) \\ and & \\ h ( w ) = \{ \begin{matrix}1 & for w < {w}_{d} - x \\ cos [ \frac{π}{2 x} ( w - ( {w}_{d} - x - 0.4 ) ) ] & for w = {w}_{d} - x + 1 \\ cos [ \frac{π}{2 x} ( w - ( {w}_{d} - x ) ) ] & for {w}_{d} - x + 1 < w < {w}_{d} + x - 1 \\ cos [ \frac{π}{2 x} ( w - ( {w}_{d} - x + 0.4 ) ) ] & for w = {w}_{d} + x - 1 \\ - 1 & for w > {w}_{d} + x\end{matrix} & ( 14 )\end{matrix}$$

and where φ₀ is an initial phase, and x is a parameter that is set based on the number of window intervals that the phase takes to reach its final phase shift (e.g., 180 degrees).

Once the mathematical formula representing an ideal phase vs. window curve is generated in step 940, and the phase data for each window index w is generated by the steps 905-935, then in step 945 a data fitting routine such as least mean squares fits g(w) to the measured data by finding values for φ₀ and w_{d}.

In step 950, the fitted delay w_{d} (which can be non-integer) is saved. The fact that w_{d} can be non-integer improves the resolution of this embodiment beyond the resolution of method 600. Then the time t_{φRX} of the received phase transition 425 is calculated as:

t_{φRX}=T*w_{d} (15)

In step 960, the time-of-flight t_{TOF} of the signal is determined using equation (4) above.

Finally, in step 965, the process ends.

Another alternative embodiment uses a cross-correlation technique to find the index w of the window 320 where phase transition 425 occurs in received signal 310. As opposed to an algorithm that attempts to cross correlate the amplitude of the received signal to an ideal representation of the received signal, this embodiment cross-correlates the windowed phase data from the received signal 310 with an ideal windowed phase curve. As the ideal phase response is stepped through the sampled data from received signal 310, the maximum of the cross-correlation, C_{MAX}, a gives the location of phase transition 425. Thus:

t_{φRX}=T*c_{MAX} (16)

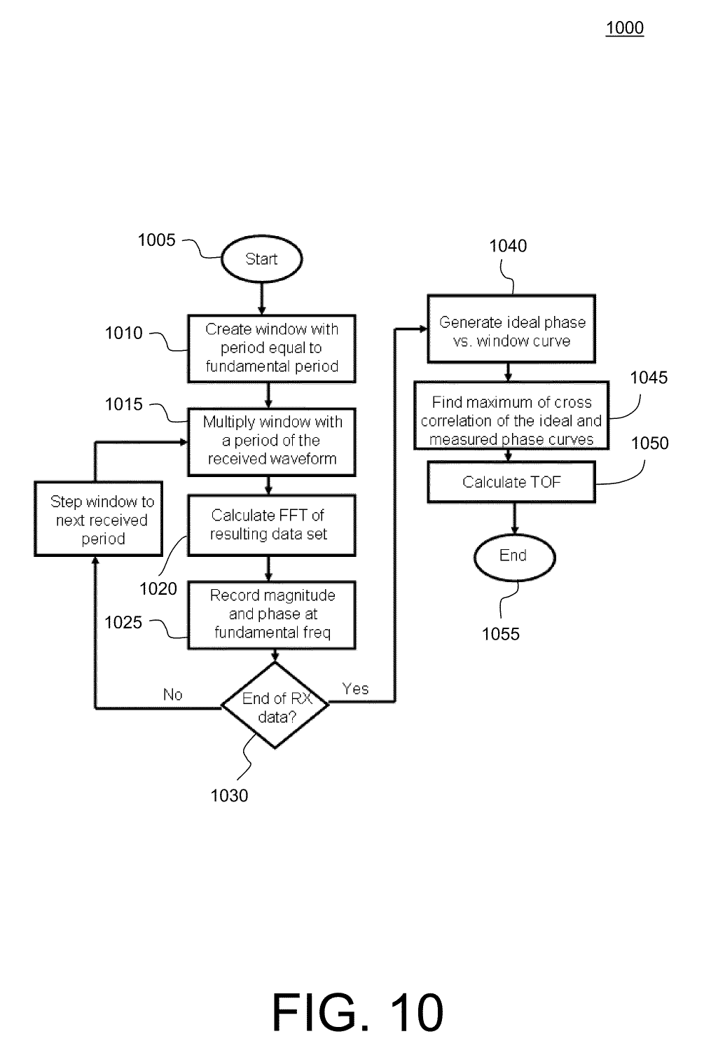

FIG. 10 illustrates a flow chart of yet another embodiment of a method 1000 of determining the time-of-flight t_{TOF} of a signal.

Steps 1005-1035 of method 1000 are the same as steps 605-635 of method 600 described above, and so a description thereof will not be repeated here.

In step 1040, an ideal windowed phase curve is generated based on the transmitted signal.

In step 1045, the windowed phase data from the received signal 310 is cross-correlated with the ideal windowed phase curve, and the index w of the window 320 having the cross-correlation maximum or peak, w_{φRX} is established as the window 320 where phase transition 425 occurs in the received signal.

From w_{φRX} in step 1050 the time-of-flight t_{TOF} of the signal is determined using equations (3) and (4) above.

Finally, in step 1055, the process ends.

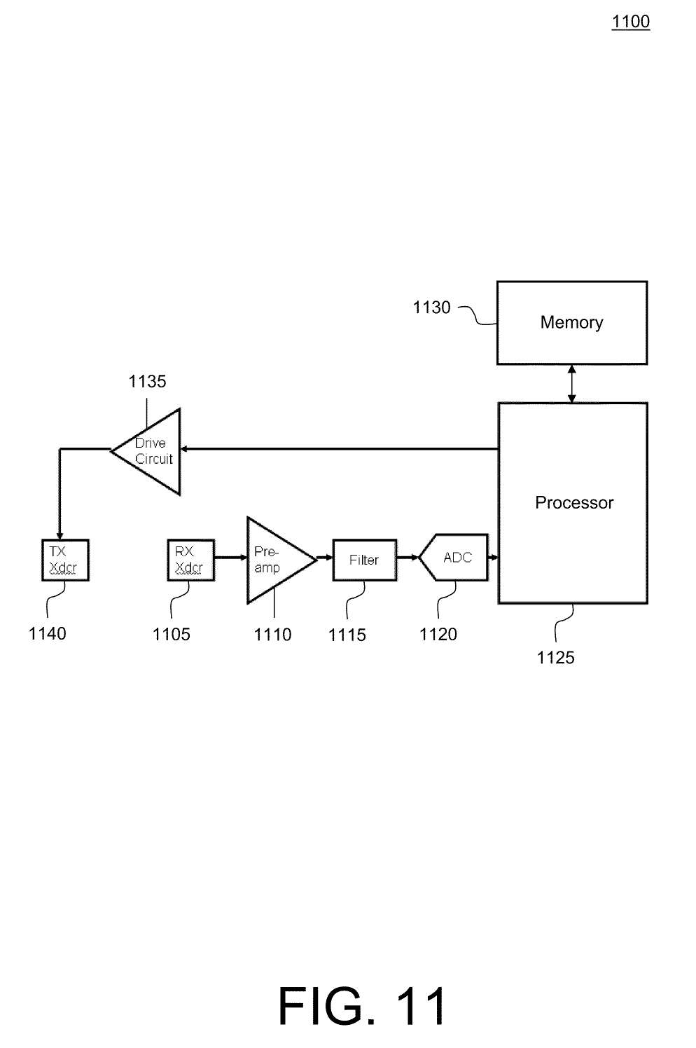

FIG. 11 illustrates on embodiment of a system 1100 for measuring the time-of-flight of a signal using one or more of the methods described above. System 1100 includes a receive transducer 1105, an optional pre-amplifier 1110, an optional filter 1115, an analog-to-digital converter (ADC) 1120, a processor 1125, a memory 1130, a drive circuit 1135, and a transmit transducer 1140.

In some embodiments, receive transducer 1105 and transmit transducer 1150 are each acoustic transducers—for example, ultrasonic transducers.

Processor 1125 may be a general purpose digital signal processor (DSP), microcontroller, programmable logic device, programmable gate array, custom ASIC, or a general purpose microprocessor executing a computer program, the executable code for which may be stored, for example, in memory 1130. Beneficially, processor 1125 generates either a digital transmit signal or an analog transmit signal via an on-board digital-to-analog converter (DAC). This signal may be routed to drive circuit 1130 which amplifies the signal or otherwise converters it for application to transmit transducer 1135. The received signal from receive transducer 1105 may be amplified by preamplifier 1110, and then (optionally) is filtered by filter 1115 and then sampled with ADC 1120. In an alternative embodiment, the analog-to-digital-conversion function may be performed with processor 1125.

In some embodiments, the sampled receive data may require further manipulation or processing before the TOF measurement methods described above may be performed.

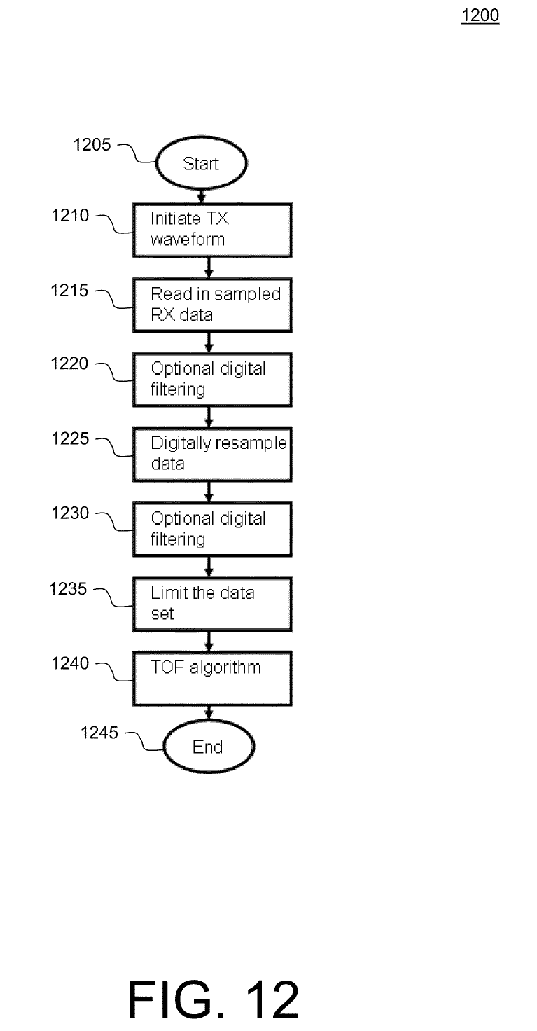

FIG. 12 illustrates a flow chart of an embodiment of a method 1200 of determining the time-of-flight of a signal that includes some preprocessing of the sampled receive data prior to executing one of the TOF measurement method described above.

The process starts at step 1205.

At step 1210, processor 1125 initiates or generates the transmit waveform (see, e.g., FIG. 2) and sends the waveform to transmit transducer 1135, for example via drive circuit 1130. The signal is later received at receive transducer 1105, and in step 1215 the received signal is sampled by ADC 1120 at some sampling rate dictated by system constraints such as hardware, cost, EMI, etc. In an optional step 1220, the sampled receive data may now be filtered by an appropriate digital filter such as a finite impulse response (FIR), infinite impulse response (IIR), adaptive filter, wiener filter, least-mean-square filter, etc. This filter could be eliminated if the sampled receive data already has sufficient fidelity. In an alternative arrangement, the filtering can be moved to a point later in the signal processing path. In an optional step 1225, the sampled receive data is then digitally resampled so that the number of data samples, M, in each fundamental period T is an integer. This makes the processing of the data in the subsequent short-time FFT easier. Step 1225 may be omitted if the data is already sampled in hardware at the desired integer multiple of the fundamental frequency F. After resampling, in an optional step 1230, the receive data may again be filtered with an appropriate digital filter to enhance fidelity.

In some cases, the receive signal 310 may be such that areas of received signal 310 far from the actual phase transition time 425 provide erroneous data that causes false positives in the algorithm.

Accordingly, in an optional step 1235, the sampled receive data set may be limited by one or more means. In one embodiment, a TOF seed value is employed, based on user or system input as a region to look for phase transition 425. This seed may be made adaptive based on past values of the TOF and/or phase transition 425 or it may employ feedback from some other sensor or input. In another embodiment, all receive data that is below a certain amplitude threshold is simply ignored, thereby eliminating unreliable data. In yet another embodiment, the receive data set is limited by performing a cross-correlation of the amplitude to find a likely region for phase transition 425, and that is employed as a TOF seed.

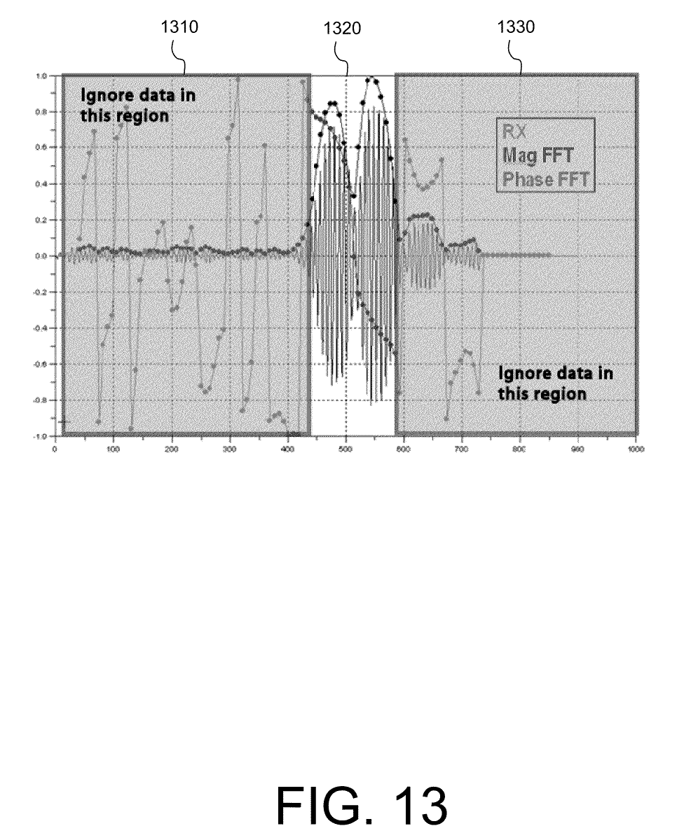

FIG. 13 illustrates an example of limiting a received data set to a region of interest 1320 around a time 425 where a phase transition occurs by ignoring receive data in the regions 1310 and 1320 that are relatively far away from transition time 425.

Turning back again to method 1200, in step 1250 a method such as any of the methods described above (for example with respect to FIGS. 3-10) is employed using the pre-processed receive data to measure the time-of-flight t_{TOF} of the signal.

Then in step 1245, the process ends.

While example embodiments are disclosed herein, one of ordinary skill in the art appreciates that many variations that are in accordance with the present teachings are possible that remain within the scope of the appended claims. The embodiments therefore are not to be restricted except within the scope of the appended claims.

1. A method, comprising:
receiving a signal having a first series of first pulses each having a fundamental period T and each being substantially at zero degrees in phase with respect to each other, and having a second series of second pulses following in time after the series of first pulses, the second pulses also having the fundamental period T and each being shifted in phase with respect to the first pulses;
(1) providing a window having a width substantially the same as the fundamental period T;
(2) aligning the window with a w^{th} interval of the received signal within the first series of first pulses;
(3) multiplying the received signal by the window to produce a product for the w^{th} interval of the received signal;
(4) determining a magnitude and phase of the product for the w^{th} interval at a fundamental frequency F=1/T;
(5) incrementing w by one, delaying the window by one fundamental period, and repeating steps (2) through (4) to produce N sets of magnitude and phase data at the fundamental frequency F for N intervals of the received signal spanning at least one of the first pulses and at least one of the second pulses;
(6) from the N sets of magnitude and phase data, determining when a phase transition occurs in the received signal due to a transition from the first pulses to the second pulses; and
(7) determining a time-of-flight of the signal from a time when the phase transition occurs in the received signal.

2. The method of claim 1, wherein determining the magnitude and phase of the product for the w^{th} interval at the fundamental frequency F comprises performing a fast Fourier transform on the product.

3. The method of claim 1, wherein determining the magnitude and phase of the product for the w^{th} interval at the fundamental frequency F comprises:
determining a real part of a Fourier transform of the product for the w^{th} interval at the fundamental frequency by multiplying the product by a cosine function of the fundamental frequency;
determining an imaginary part of the Fourier transform of the product for the W^{th} interval at the fundamental frequency by multiplying the product by a sine function of the fundamental frequency; and
determining the magnitude and phase of the product for the w^{th} interval at the fundamental frequency F from the real and imaginary parts of the Fourier transform of the product at the fundamental frequency.

4. The method of claim 1, wherein determining the magnitude and phase of the product for the w^{th} interval at the fundamental frequency F comprises performing a wavelet transform on the product.

5. The method of claim 1, wherein determining when a phase transition occurs in the received signal comprises determining a p^{th} one of the N intervals of the received signal where the phase transition occurs.

6. The method of claim 5, wherein determining the p^{th} interval of the received signal where the phase transition occurs comprises taking the absolute value of the derivative of the phase data and determining an interval among the N intervals corresponding to a peak in the derivative.

7. The method of claim 6, further comprising determining, within the p^{th} interval where the phase transition occurs, a sample of the received signal corresponding to when the phase transition occurs.

8. The method of claim 7, wherein the window corresponds to M samples of the received signal, and wherein determining, within the p^{th} interval when the phase transition occurs, a sample of the received signal corresponding to when the phase transition occurs, comprises:
(8) for j=(1, M): delaying the window by j data samples in time and repeating steps (2) through (6) and determining a one of the N intervals of the received signal where a phase transition occurs for the window delayed by j data samples; and
(9) determining a k^{th} one of the M samples where the interval where the phase transition occurs changes from the p^{th} interval to the (p^{th}−1) interval; and
(10) identifying the k^{th} sample within the p^{th} interval as the sample of the received signal corresponding to when the phase transition occurs within the p^{th} window.

9. The method of claim 5, wherein further comprising determining a phase of the first pulses of the received signal by averaging the phase data for several intervals prior to the p^{th} interval.

10. The method of claim 1, wherein determining when the phase transition occurs in the received signal comprises:
generating a mathematical formula representing an ideal phase of the received signal as a function of time;
determining a best fit for the N sets of phase data on the mathematical formula; and
determining where the phase transition occurs from the best-fit phase data.

11. The method of claim 1, wherein determining when the phase transition occurs in the received signal comprises:
generating ideal phase data representing an ideal windowed phase of the received signal at the frequency F as a function of the N intervals;
cross-correlating the N sets of phase data with the ideal phase data; and
determining a p^{th} one of the N intervals of the received signal where the cross-correlation has a maximum.

12. A method, comprising:
receiving a signal having a series of pulses of period T, the series of pulses having a phase transition provided therein;
windowing the received signal with a window having a width substantially the same as T to determine a magnitude and phase of the windowed signal at a frequency F=1/T;
sliding the window in time, one period T at a time, with respect to the received signal to produce a plurality of N sets of magnitude and phase data at the frequency F;
from the N sets of magnitude and phase data, determining a time when the phase transition occurs in the received signal; and
determining a time-of-flight of the signal from the time when the phase transition occurs in the received signal.

13. The method of claim 12, further comprising:
transmitting the signal;
storing a time when the phase transition occurs in the transmit signal; and
determining the time-of-flight of the signal as a difference between when the phase transition occurs in the transmit signal and the time when the phase transition occurs in the received signal.

14. The method of claim 12, wherein receiving the signal includes sampling the signal at a sampling rate that is substantially the same as an integer multiple of F.

15. The method of claim 12, wherein determining the magnitude and phase of the windowed signal at the frequency F comprises one of performing a fast Fourier transform on the windowed signal and performing a wavelet transform on the windowed signal.

16. The method of claim 12, further comprising, prior to windowing the received signal, limiting a time period of the received signal to be windowed to a region around the time when the phase transition occurs in the received signal.

17. A system, comprising:
a receiver configured to receive a signal having a series of pulses of period T, the series of pulses having a phase transition provided therein; and
a processor configured to execute an algorithm comprising:
windowing the received signal with a window having a width substantially the same as T to determine a magnitude and phase of the windowed signal at a frequency F=11T;
sliding the window in time, one period T at a time, with respect to the received signal to produce a plurality of N sets of magnitude and phase data at the frequency F;
from the N sets of magnitude and phase data, determining a time when the phase transition occurs in the received signal; and
determining a time-of-flight of the signal from the time when the phase transition occurs in the received signal.

18. The system of claim 17, wherein the receiver includes:
a receive transducer; and
an amplifier and an analog-to-digital converter arranged to in series with an output of the receive transducer to amplify and digitize the received signal.

19. The system of claim 17, further comprising:
a drive circuit; and
a transmit transducer connected to an output of the drive circuit and configured to transmit the signal having the series of pulses of period T with the phase transition provided therein,
wherein the drive circuit receives from the processor a signal to be transmitted.

20. The system of claim 17, wherein the receiver is configured to sample the signal at a sampling rate that is substantially the same as an integer multiple of F.
